(19) United States
(12) Patent Application Publication
(10) Pub. No.: US 2010/0329662 A1
(43) Pub. Date: Dec. 30, 2010

(54) Photographing Device of a Global Positioning System

(76) Inventor: Cheng-Chien Hsu, Sijhih City (TW)

Correspondence Address: Muncy, Geissler, Olds & Lowe, PLLC, 4000 Legato Road, Suite 310, FAIRFAX, VA, 22033, US

(21) Appl. No.: 12/189,144

(22) Filed: Aug. 9, 2008

(51) Int. Cl. G03B 29/00

(52) U.S. Cl. 396/429

(57) ABSTRACT

A photographing device of a global positioning system includes a casing, a display screen, a control circuit board and a photographing device. A side of the casing is the display screen, the casing contains a holding space, and the holding space includes the photographing device which is assembled with the control circuit board by an electric connection assembly. The control circuit board includes an access unit, a positioning and transmission unit, a computing unit and a battery unit. When the photographing device is used, the photographing device starts to shoot and record. Next time when a car is driving on a route, an image of which is stored by the photographing device, the photographing device compares the route image recorded with the route image planned by a user; after comparison, the route image that fits is transmitted to the display screen by the access unit to facilitate watching.

### BACKGROUND OF THE INVENTION

a) Field of the Invention

The present invention relates to a device of a global positioning system, and more particularly to a photographing device of a global positioning system, which allows routes planned by a user to be watched dynamically.

b) Description of the Prior Art

In an old time, people almost always uses a map set to find a route needed when looking for a road. However, not every road is provided with a road sign, and usually the road that is looked for is only a small alley; therefore, it will always waste a lot of time for the user to look up the map for finding the road. Furthermore, some area is not able to be shown in the map set.

In a modern time with such progressive technologies, people are starting to develop many electronic consumable products, and a primary electronic consumable product used to replace the old map set is a global positioning system which is a very convenience and precise electronic map compared to the old map set. In addition, many major electronic companies in markets, such as Panasonic, ASUS or E-TEN, have also started to produce the global positioning systems.

A preliminary global positioning system is not able to update its content information; therefore, the global positioning system cannot be aware of related information if there is update of a road sign or new construction of a road. Accordingly, the developing companies start to develop a global positioning system which is updatable and is provided with a voice function. This kind of global positioning system facilitates many drivers; especially that the new voice system allows the user to identify the routes without watching at a display screen, and also significantly improves driving safety.

Nevertheless, in using the aforementioned global positioning system, following problems and shortcomings actually exist to be improved.

When the user is employing the global positioning system, the routes that the user has driven by cannot be recorded nor can be watched at dynamically. Furthermore, although that global positioning system is provided with the voice assistance, some reliability is still in short of in terms of explicitness of marking, and there is no fun.

Accordingly, how to solve the aforementioned problems and shortcomings of the prior art is an aim of improvement with research and development by the present inventor and related vendors.

### SUMMARY OF THE INVENTION

The primary object of the present invention is to provide a photographing device of a global positioning system, wherein a side of a casing of the global positioning system is provided with a display screen, and an interior of the casing is formed with a holding space which is provided with a control circuit board having an access unit, a positioning and transmission unit, a computing unit and a battery unit. A pre-determined position on the control circuit board is provided with an electric connection assembly which is connected to a photographing device. Accordingly, when the photographing device of the global positioning system is used, the photographing device starts to shoot and record, as well as executes simultaneously with the positioning and transmission unit. In addition, data that has been shot and recorded by the photographing device is stored into a memory through the access unit. By the aforementioned technologies, the problems existing in the conventional global positioning system that the routes planned cannot be watched at dynamically and the routes that have been driven by cannot be watched at can be solved, thereby achieving the practicability and progressiveness that the routes planned can be watched at dynamically and the routes that have been driven by can be watched at.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of a preferred embodiment of the present invention.

FIG. 3 shows a first schematic view of an implementation of a preferred embodiment of the present invention.

FIG. 4 shows a second schematic view of an implementation of a preferred embodiment of the present invention.

FIG. 5 shows a third schematic view of an implementation of a preferred embodiment of the present invention.

FIG. 6 shows a fourth schematic view of an implementation of a preferred embodiment of the present invention.

### DETAILED DESCRIPTION OF THE PREFERRED EMBODIMENTS

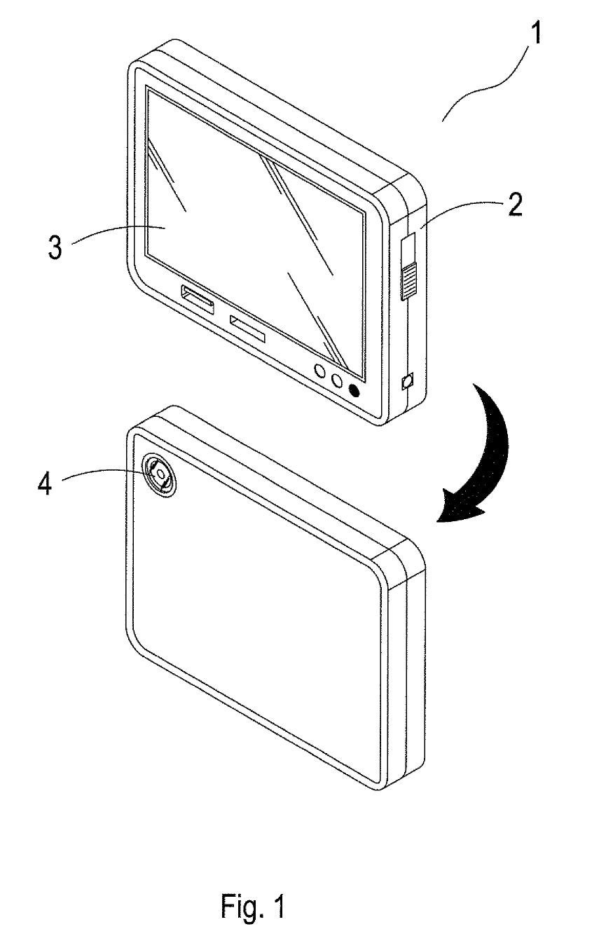

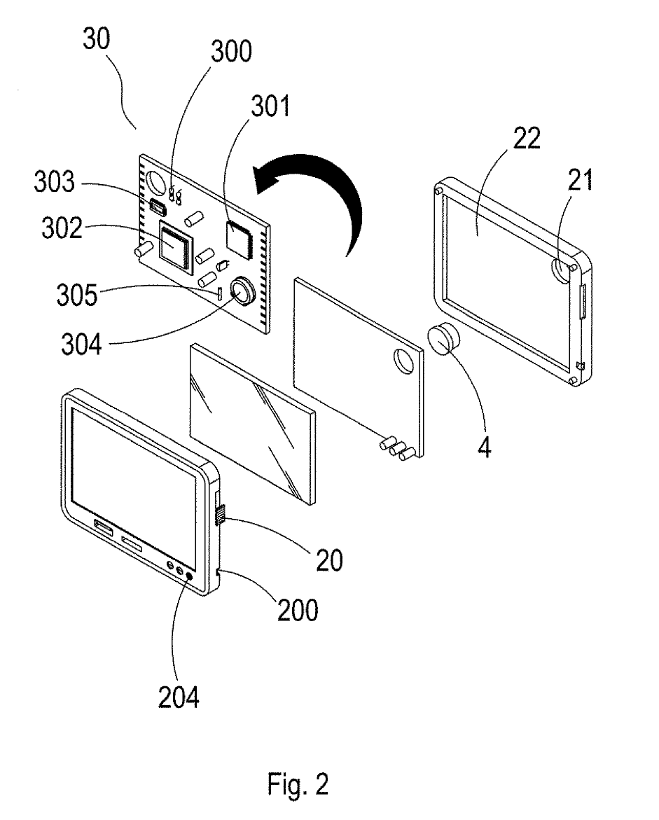

Referring to FIG. 1 and FIG. 2, it shows a three-dimensional view and an exploded view, of a preferred embodiment of the present invention. A photographing device of a global positioning system 1 comprises a casing 2, a display screen 3, a control circuit board 30 and a photographing device 4, wherein a side of the casing 2 is provided with the display screen 3, the other side of the casing 2 is formed with a lens hole 21, and a side edge of the casing 2 is provided with an OFF/ON switch 20 and a power hole 200. Moreover, an interior of the casing 2 is formed with a holding space 22 which is provided with the control circuit board 30, the control circuit board 30 is provided with a positioning and transmission unit 301, a computing unit 302, an access unit 303 and a battery unit 304, and a pre-determined position on the control circuit board 30 is provided with an electric connection assembly 300 that is connected to the photographing device 4. In addition, the photographing device of that global positioning system 1 can be further provided with a voice recording device 204 which is connected to the control circuit board 30 through an electric transmission assembly 305.

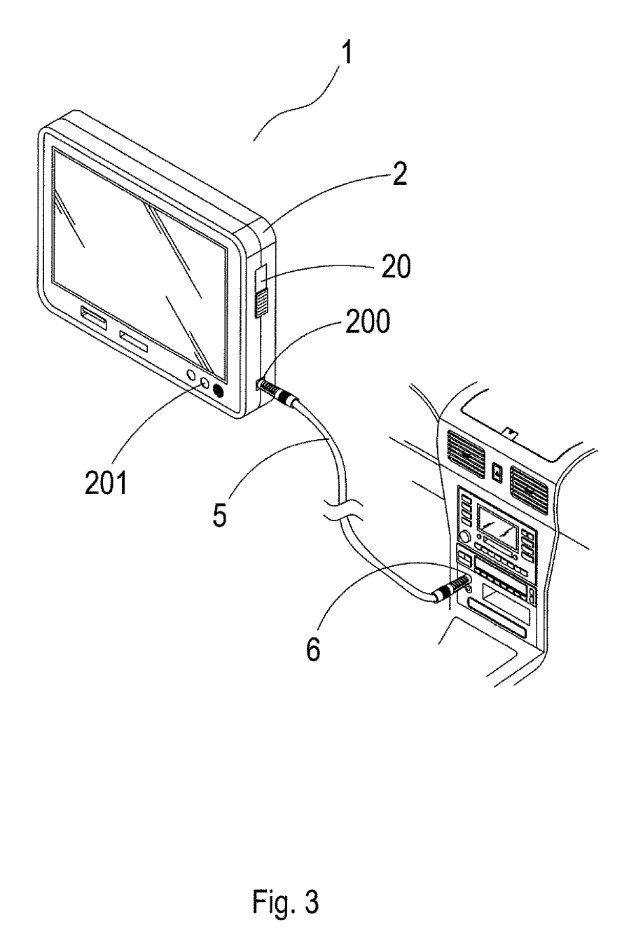

Referring to FIG. 3, it shows a first schematic view of an implementation of a preferred embodiment of the present invention. A lighting element 201 is provided on a side edge of the casing 2, and when the photographing device of the global positioning system 1 is activated by pressing the switch 20, the lighting element 201 starts to illuminate.

Moreover, when the photographing device of the global positioning system 1 is used, the power hole 200 is connected with a power cable 5 which corresponds to a car-use power socket 6. When the power cable 5 is connected to the car-use power socket 6, the photographing device of the global positioning system 1 is energized. In addition, when the user has pressed down the OFF/ON switch 20, the photographing device of the global positioning system 1 will be activated, and the lighting element 201 illuminates at a same time.

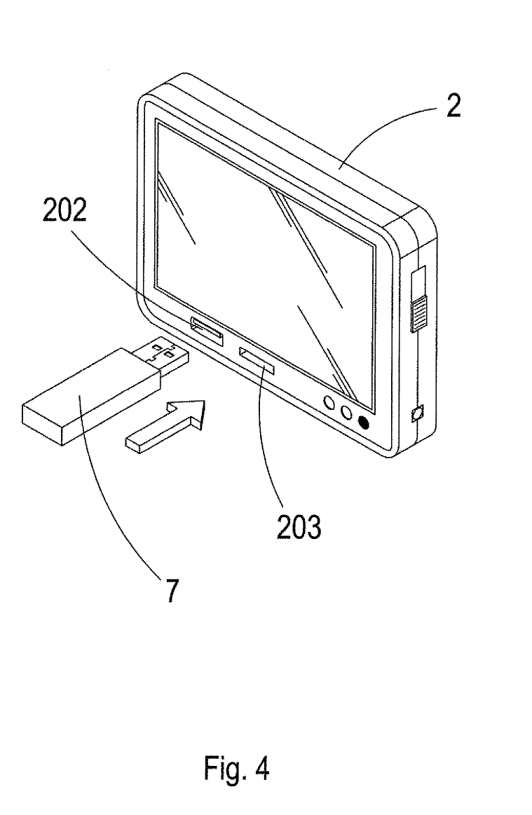

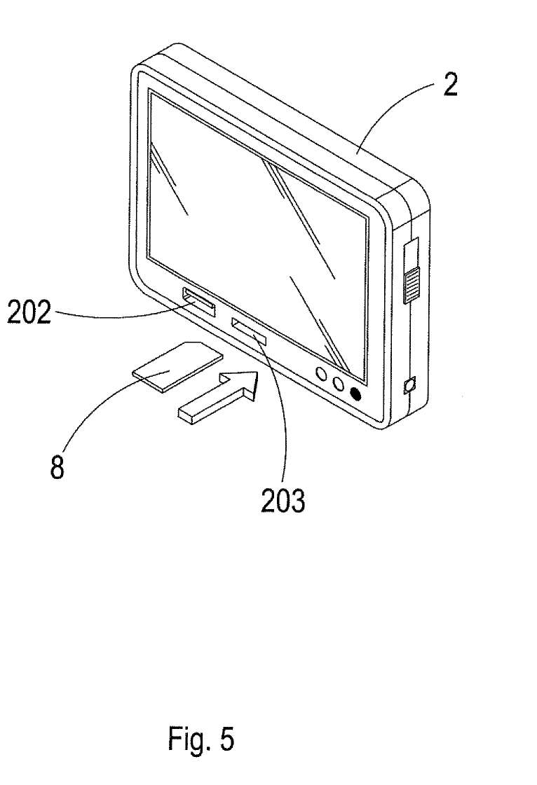

Referring to FIG. 4 and FIG. 5, it shows a second schematic view of an implementation and a third schematic view of an implementation, of a preferred embodiment of the present invention. A side edge of the casing 2 is provided with a USB (Universal Serial Bus) slot 202 and a memory card slot 203. That USB slot 202 can be inserted with a compatible personal disk 7, and that memory card slot 203 can be also inserted with a compatible memory card 8.

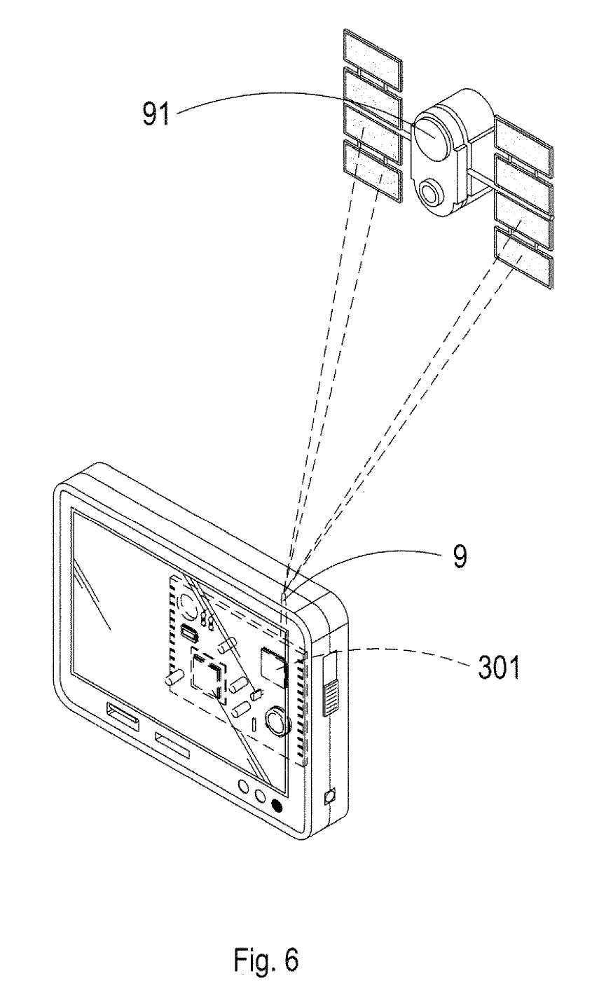

Referring to FIG. 6, it shows a fourth schematic view of a preferred embodiment of the present invention, wherein the positioning and transmission unit 301 is provided with a transmission antenna 9 which is used to link with a satellite 91.

Referring to all the drawings, the present invention is actually provided with following advantages in comparison with the prior art:
1. When the photographing device of the global positioning system 1 is activated, the positioning and transmission unit 301 starts to transmit a signal, and a content of the signal is displayed on the display screen 3 at a same time. In addition, a recording function of the photographing device 4 can be turned on or turned off according to the user's demands. When the photographing device 4 is turned on, the access unit 303 starts to access images that are shot and recorded by the photographing device 4. After accomplishing the shooting and recording by the photographing device 4, the photographing device 4 can be connected with the global positioning system, allowing the user to watch at the images dynamically for a next usage.
2. The USB slot 202 can be used by the photographing device of the global positioning system 1 for allowing the personal disk 7 to access or read data of the global positioning system at any time, and the memory card slot 203 can used to expand memory capacity of the global positioning system 1.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A photographing device of a global positioning system, with that global positioning system comprising a casing, a side of which is provided with a display screen, and an interior of which is formed with a holding space that is provided with a control circuit board having an access unit, a positioning and transmission unit, a computing unit and a battery unit; an interior of the global positioning system being provided with a photographing device, and a pre-determined position inside the global positioning system being provided with an electric connection assembly which is connected to that photographing device.

2. The photographing device of a global positioning system, according to claim 1, wherein the positioning and transmission unit is provided with a transmission antenna.

3. The photographing device of a global positioning system, according to claim 1, wherein the global positioning system is further provided with a voice recording device, a pre-determined position inside which is provided with an electric connection assembly being connected to the control circuit board.
